(19) United States
(12) Patent Application Publication
(10) Pub. No.: US 2019/0066166 A1
(43) Pub. Date: Feb. 28, 2019

(54) METHOD FOR GENERATING VIRTUAL REALITY IMAGE INCLUDING ADVERTISEMENT

(71) Applicant: Hyung Suk Oh, Seoul (KR)

(72) Inventor: Hyung Suk Oh, Seoul (KR)

(21) Appl. No.: 16/115,826

(22) Filed: Aug. 29, 2018

(30) Foreign Application Priority Data
Aug. 30, 2017 (KR) 10-2017-0110132

(51) Int. Cl. G06Q 30/02; G06T 19/00

(52) U.S. Cl. CPC G06Q 30/0276; G06T 19/006

(57) ABSTRACT

A method for generating a virtual reality (VR) image by a computer includes disposing at least one advertisement area in the generated virtual reality image; inserting an advertisement into the advertisement area: and generating a virtual reality image including the inserted advertisement.

### REFERENCE TO RELATED APPLICATIONS

This application claims the priority benefit of Korean Patent Application No. 10-2017-0110132 filed on Aug. 30, 2017, the entire contents of which are incorporated herein by reference.

### FIELD OF THE INVENTION

The present disclosure relates to a method for generating a virtual reality image including an advertisement.

### BACKGROUND OF THE INVENTION

Virtual Reality (VR) is a human-computer interface which creates a specific environment or situation by a computer to allow a user to feel as if the user interacts with the actual surrounding situation and environment. Augmented Reality (AR) is a technology which superimposes a virtual object on a user's view of the real world. Augmented Reality is also referred to as Mixed Reality (MR) because it combines the real world with the virtual world having additional information in real time to show a single image.

### SUMMARY OF THE INVENTION

An object to be achieved by the present disclosure is to provide a method for generating a virtual reality image including an advertisement.

Technical problems of the present invention are not limited to the above-mentioned technical problems, and other technical problems, which are not mentioned above, can be clearly understood by those skilled in the art from the following descriptions.

According to an aspect of the present disclosure, a method for generating a virtual reality (VR) image by a computer includes: disposing at least one advertisement area in the generated virtual reality image, inserting an advertisement into the advertisement area, and generating a virtual reality image including the inserted advertisement.

The inserting of an advertisement into the advertisement area may include determining an advertisement to be inserted into the advertisement area and inserting the determined advertisement into the advertisement area and the generating of a virtual reality image may include regenerating a virtual reality image including the determined advertisement.

Further, the regenerating may include regenerating the virtual reality image by rendering only the advertisement area again in the virtual reality image.

The virtual reality image may include metadata corresponding to the advertisement and when the advertisement is selected by a virtual reality device, the metadata corresponding to the advertisement may be provided to a user of the virtual reality device.

Further, a computer program which is combined with a computer which is a hardware to be stored in a computer-readable recording medium to perform the method for generating a virtual reality image according to the present disclosure is provided.

Other detailed matters of the present disclosure are included in the detailed description and the drawings.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a conceptual view illustrating a system which generates a virtual reality image including an advertisement according to an exemplary embodiment;

FIG. 2 is a flowchart illustrating a method for generating a virtual reality image including an advertisement according to an exemplary embodiment; and

FIG. 3 is a view illustrating a virtual reality image according to an exemplary embodiment.

### DETAILED DESCRIPTION OF THE INVENTION

Advantages and characteristics of the present invention and a method of achieving the advantages and characteristics will be clear by referring to exemplary embodiments described below in detail together with the accompanying drawings. However, the present invention is not limited to the exemplary embodiments disclosed herein but will be implemented in various different forms. The exemplary embodiments are provided by way of example only so that a person of ordinary skilled in the art can fully understand the disclosures of the present invention and the scope of the present invention. Therefore, the present invention will be defined only by the scope of the appended claims.

The terms used in the present specification are for explaining the embodiments rather than limiting the present disclosure. Unless particularly stated otherwise in the present specification, a singular form also includes a plural form. The terms “comprise” and/or “comprising” used in the specification do not exclude the presence or addition of one or more other components in addition to the mentioned component. Like reference numerals generally denote like components throughout the specification and “and/or” includes each of mentioned components and all combinations of one or more components. Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

Unless otherwise defined, all terms (including technical and scientific terms) used in the present specification may be used as the meaning which may be commonly understood by the person with ordinary skill in the art, to which the present invention belongs. It will be further understood that terms defined in commonly used dictionaries should not be interpreted in an idealized or excessive sense unless expressly and specifically defined.

The term “˜unit” or “˜module” used in the specification refers to a hardware component such as FPGA or ASIC and the “unit” or “module” performs some functions. However, “unit” or “module” is not limited to the software or the hardware. “˜unit” or “˜module” may be configured to be in an addressable storage medium or may be configured to reproduce one or more processors. Accordingly, as an example, “˜unit” or “˜module” includes components such as software components, objectoriented software components, class components, and task components, processes, functions, attributes, procedures, subroutines, segments of a program code, drivers, a firmware, a microcode, a circuit, data, database, data structures, tables, arrays, and variables. A function which is provided in the components and “˜units” or “˜modules” may be combined with a smaller number of components and “˜units” or “˜modules” or divided into additional components and “˜units” or “˜modules”.

Spatially relative terms such as “below”, “beneath”, “lower”, “above”, or “upper” may be used to easily describe the correlation between one component and other components as illustrated in the drawings. The spatially relative terms should be understood to include different directions of the components when the components are used or operated in addition to the direction illustrated in the drawings. For example, when the component illustrated in the drawing is turned over, a component which is disposed below or beneath another component may be disposed above the other component. Accordingly, the exemplary term “below” or “beneath” may include both downward and upward directions. The components may be oriented in different directions so that terms which are spatially relative may be interpreted according to the orientation.

In the specification, the virtual reality and the virtual reality image are not limited to the VR and the VR reality but include all virtual reality (VR), virtual reality images, augmented reality (AR), augmented reality images, mixed reality (MR), mixed reality images, and normal images. Further, the virtual reality and the virtual reality image are not limited thereto and include any type of images such as real images, virtual images, and mixed images of real images and virtual images.

Hereinafter, exemplary embodiments will be described in detail with reference to the accompanying drawings.

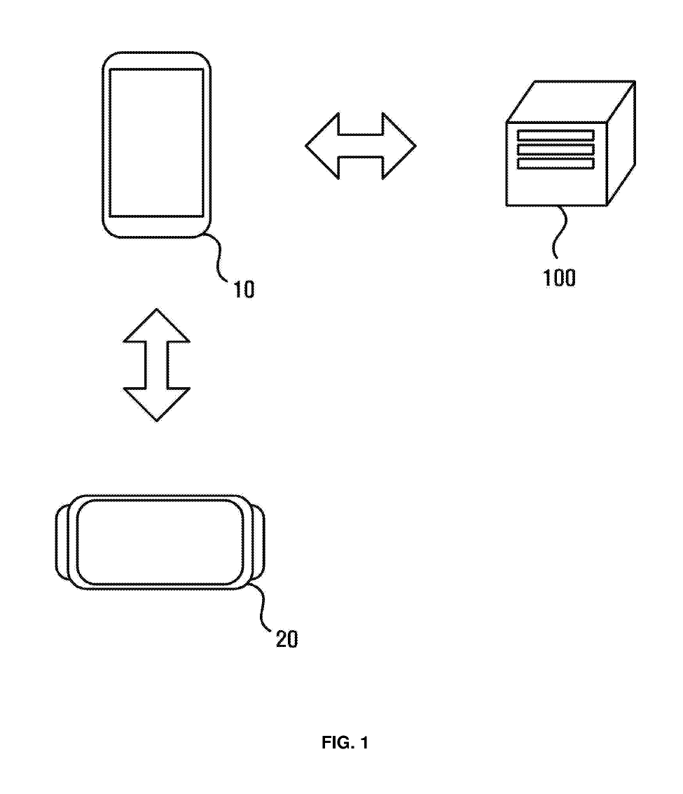

FIG. 1 is a conceptual view illustrating a system which generates a virtual reality image including an advertisement according to an exemplary embodiment.

Referring to FIG. 1, a system includes a user terminal 10, a virtual reality device 20, and a computer 100.

According to an exemplary embodiment, the virtual reality device 20 includes at least one display.

Here, the display may include at least one or a combination of two or more of a liquid crystal display, a thin film transistor liquid crystal display, an organic light emitting diode, a flexible display, a three-dimensional display, a head mount display (HMD), a smart glass, and other virtual reality image watching devices. Further, the type of displays described in the specification is not limited thereto and includes any type of device which is capable of displaying images.

Further, the user terminal 10 and the computer 100 refer to computing devices including at least one processor. The computing device may refer to a desktop computer, a laptop computer, a smart phone, a table PC, and a server, but is not limited thereto.

In one exemplary embodiment, the computer 100 may refer to a cloud server. For example, the user terminal 10 performs virtual reality image rendering through a cloud server and the method of generating a virtual reality image according to the disclosed exemplary embodiment may be performed in the cloud server.

In one exemplary embodiment, the user terminal 10 and the virtual device 20 are not divided, but may operate as a whole. In another exemplary embodiment, the terminal 10 and the virtual reality device 20 are physically or electrically connected to each other.

In one exemplary embodiment, the user terminal 10 and the computer 100 are not distinguished but may be referred to as the same computing device. In another exemplary embodiment, the user terminal 10 may be a client terminal of the user and the computer 100 may be a server.

Therefore, in the disclosed exemplary embodiment, at least some or all of the operations described as operations performed by the user terminal 10 may also be performed in the computer 100. Further, at least some or all of the operations described as operations performed by the computer 100 may also be performed in the user terminal 10.

In the disclosed exemplary embodiment, the virtual reality image is generated in the computer 100 and is displayed in the virtual reality device 20.

In one exemplary embodiment, the user terminal 10 transmits materials for generating a virtual reality image to the computer 100 and the computer 100 generates the virtual reality image and transmits the generated virtual reality image to the user terminal 10.

For example, the user terminal 10 transmits a plurality of images for generating a virtual reality image to the computer 100 and the computer 100 may generate the virtual reality image by stitching the plurality of images. The computer 100 may insert an advertisement into at least a part of the generated virtual reality image. For example, the computer 100 may insert an advertisement banner in at least a part of the generated virtual reality image.

As another example, the user terminal 10 transmits a keyword or at least one image for generating a virtual reality image to the computer 100 and the computer 100 obtains one or more images from an external server based on information obtained from the user terminal 10 and stitches the one or more images to generate a virtual reality image.

In one exemplary embodiment, the computer 100 may insert at least one visual effect (VFX) into the virtual reality image upon the request from the user terminal 10. The computer 100 may insert at least one advertisement banner together with the VFX into the virtual reality image.

The user terminal 10 displays the received virtual reality image using the virtual reality device 20.

In one exemplary embodiment, the user terminal 10 may modify at least a part of the received virtual reality image. For example, the user terminal 10 changes the advertisement banner displayed in the received virtual reality image into another advertisement banner and renders the changed part.

As another example, only an advertisement area into which the advertisement can be inserted is disposed in the received virtual reality image. When the user terminal 10 reproduces the virtual reality image using the virtual reality device 20, the advertisement is determined by the user terminal 10 or the computer 100 and the determined advertisement is inserted into the advertisement area. Further, the user terminal 10 or the computer 100 may render the advertisement area again to include the inserted advertisement image in the virtual reality image.

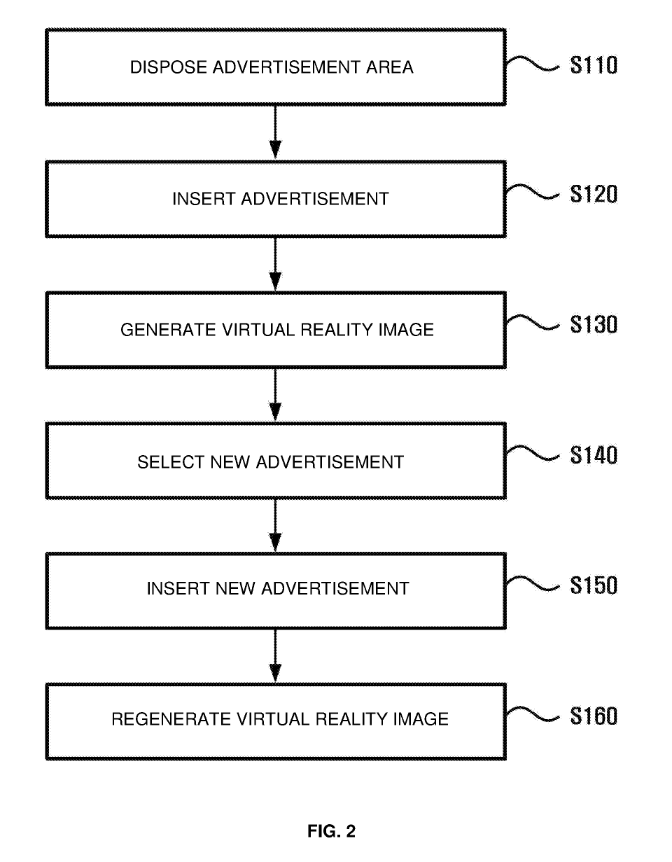

FIG. 2 is a flowchart illustrating a method for generating a virtual reality image including an advertisement according to an exemplary embodiment.

Referring to FIG. 2, a method for generating a virtual reality image including an advertisement is configured by steps which are processed in the computer 100 illustrated in FIG. 1 in a time-series manner. Therefore, contents which are omitted in the description for the method for generating a virtual reality image including an advertisement of FIG. 2 but are described in the description for the computer 100 of FIG. 1 may also be applied to the method for generating a virtual reality image including an advertisement of FIG. 2.

In step S110, the computer 100 generates a virtual reality image and disposes at least one advertisement area in the generated virtual reality image.

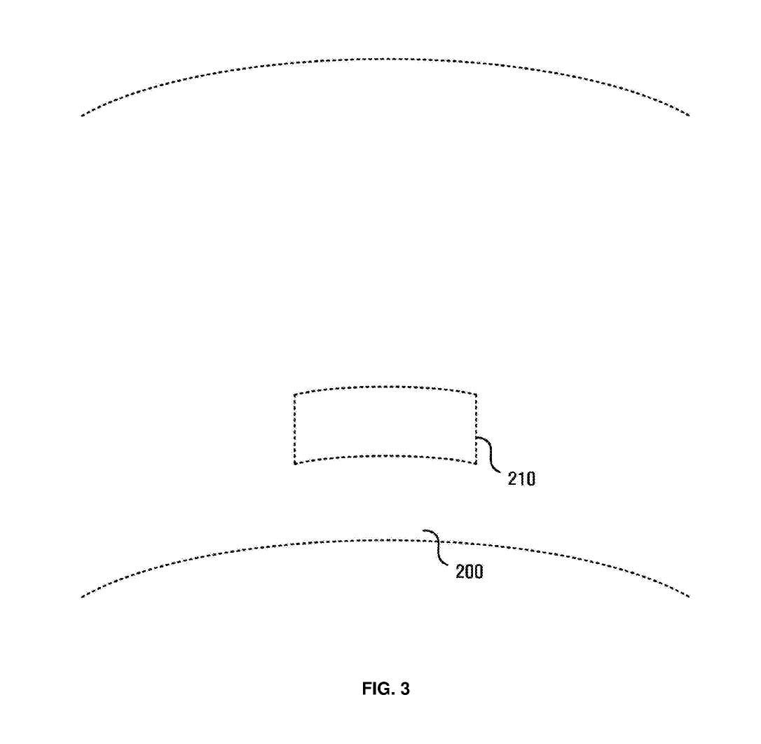

Referring to FIG. 3, an example of the virtual reality image 200 and at least one advertisement area 210 disposed in the virtual reality image 200 is illustrated.

For example, during a process of generating a virtual reality image by stitching a plurality of images upon the request from the user terminal 10 or inserting VFX into the virtual reality image, the computer 100 disposes at least one advertisement area 210 in the virtual reality image 200.

In step S120, the computer 100 inserts the advertisement into the advertisement area disposed in step S110. For example, the computer 100 inserts the advertisement banner image into the advertisement area so as to display the advertisement banner image in the advertisement area.

In one exemplary embodiment, the computer 100 generates a 3D object corresponding to the advertisement. The virtual computer 100 inserts the generated 3D object into the advertisement area of the virtual reality image.

The generated 3D object may be configured as a banner or an object in the virtual reality space. For example, the advertisement may be combined with an object existing in the virtual reality or inserted into the virtual reality image as a 3D object combined with a virtual object generated like an existing object, to be displayed.

In step S130, the computer 100 generates a virtual reality image including the advertisement inserted through steps S110 and S120. The generated virtual reality image is displayed on the virtual reality device 20 and the advertisement banner is disposed in the advertisement area 210 of the virtual reality image 200.

In step S140, the computer 100 selects a new advertisement.

It is efficient for the advertisement effect that different advertisements are displayed in the same virtual reality image depending on viewers or viewing times. For example, advertisements appropriate for users and times are selected in Internet browsers and applications using cookies to show different advertisements every time.

Similarly, the computer 100 selects a new advertisement which is different from the existing advertisement included in the virtual reality image. For example, the computer 100 may select an advertisement according to a profile of the user using Google ad.

In step S150, the computer 100 inserts the new advertisement selected in step S140 into the virtual reality image.

For example, the computer 100 inserts a banner of a new advertisement into the advertisement area 210 of the virtual reality image 200.

In step S160, the computer 100 regenerates a virtual reality image into which the new advertisement selected through steps S140 and S150 is inserted.

In one exemplary embodiment, the computer 100 renders the entire virtual reality image again to regenerate the virtual reality image.

In another exemplary embodiment, the computer 100 inserts a banner of a new advertisement only into the advertisement area of the virtual reality image where the advertisement is displayed and then partially renders only the advertisement area where the banner of the new advertisement is inserted again to regenerate the virtual reality image.

Therefore, even though it is desirable to entirely render the virtual reality image by the computer 100, a job of newly rendering only a partial area may also be performed by the user terminal 10. Therefore, different advertisements may be efficiently provided depending on a user who views the virtual reality image, a viewing time, and a viewing location.

In one exemplary embodiment, metadata corresponding to the advertisement is included in the generated virtual reality image. For example, the metadata includes link information corresponding to the advertisement or image contents corresponding to the advertisement.

When the user selects an advertisement banner disposed in the advertisement area by means of an input unit of the virtual reality device 20, the virtual reality device 20 may display a new webpage in accordance with information or a link included in the virtual reality image or a virtual reality image corresponding to the advertisement.

Further, when the user selects an advertisement banner disposed in the advertisement area by means of an input unit of the virtual reality device 20, the virtual reality device 20 transmits information on the advertisement selected by the user or selection information of the user to the user terminal 10 or the computer 100 and the computer 100 transmits information corresponding to the advertisement to the user terminal 10. For example, the computer 100 may transmit a message including a link or contents corresponding to the advertisement to the user terminal 10.

Steps of the method or algorithm described in connection with the exemplary embodiment of the present disclosure may be directly implemented by a hardware or implemented by a software module executed by the hardware or a combination thereof. The software module may reside on RAM (Random Access Memory), ROM (Read Only Memory), EPROM (Erasable Programmable ROM), EEPROM (Electrically Erasable Programmable ROM), a flash memory, a hard disk, a removable disk, a CD-ROM, or an arbitrary computer-readable recording medium known in the art to which the present invention pertains.

The exemplary embodiments of the present invention have been described with reference to the accompanying drawings, but those skilled in the art will understand that the present disclosure may be implemented in another specific form without changing the technical spirit or an essential feature thereof. Therefore, it should be understood that the above-described exemplary embodiments are illustrative in all aspects and do not limit the present disclosure.

What is claimed is:

1. A method of generating a virtual reality (VR) image by a computer, the method comprising:
disposing at least one advertisement area in the generated virtual reality image;
inserting an advertisement into the advertisement area; and
generating a virtual reality image including the inserted advertisement.

2. The method according to claim 1, wherein the inserting of an advertisement into the advertisement area includes:
determining an advertisement to be inserted into the advertisement area; and
inserting the determined advertisement into the advertisement area;
wherein the generating of a virtual reality image includes:
regenerating a virtual reality image including the determined advertisement.

3. The method according to claim 2, wherein the regenerating includes:
regenerating the virtual reality image by rendering only the advertisement area again in the virtual reality image.

4. The method according to claim 1, wherein the virtual reality image includes metadata corresponding to the advertisement and when the advertisement is selected by a virtual reality device, the metadata corresponding to the advertisement is provided to a user of the virtual reality device.

5. A computer program which is combined with a computer which is a hardware to be stored in a computer-readable recording medium to perform the method according to claim 1.
